(19) United States
(12) Patent Application Publication
(10) Pub. No.: US 2020/0228347 A1
(43) Pub. Date: Jul. 16, 2020

(54) Data Security Processing and Data Source Tracing Method, Apparatus, and Device

(71) Applicant: Alibaba Group Holding Limited, Grand Cayman (KY)

(72) Inventors: Yongliang Liu, Hangzhou (CN); Bing Wang, Hangzhou (CN); Qi Zhang, Hangzhou (CN)

(21) Appl. No.: 16/741,316

(22) Filed: Jan. 13, 2020

(30) Foreign Application Priority Data
Jan. 14, 2019 (CN) 201910030784.5

(51) Int. Cl. H04L 9/32; G06F 21/64; G06F 21/60

(52) U.S. Cl. CPC H04L 9/3247; G06F 21/602; G06F 21/606; G06F 21/64

(57) ABSTRACT

A data security processing method is disclosed, and includes obtaining subject fingerprint information of a current access subject for a carrier object, the subject fingerprint information of the current access subject being used for indicating a flow path of the carrier object; and embedding the subject fingerprint information of the current access subject into the carrier object as a digital watermark. The method is used for solving the relatively cumbersome problems of real-time risk management of sensitive data in a complicated distributed system and tracing of a data leakage after the data is leaked.

### CROSS REFERENCE TO RELATED PATENT APPLICATIONS

This application claims priority to Chinese Application No. 201910030784.5, filed on 14 Jan. 2019 and entitled “Data Security Processing and Data Source Tracing Method, Apparatus, and Device,” which is hereby incorporated by reference in its entirety.

### TECHNICAL FIELD

The present disclosure relates to the field of computer technologies, and particularly to data security processing methods, apparatuses, electronic devices, and storage devices. The present disclosure also relates to data source tracing methods, apparatuses, electronic devices, and storage devices.

### BACKGROUND

In a distributed system, a flow path of data (a carrier object) is very complicated. A certain access subject may distribute data to different access subjects, and may also obtain data from different access subjects.

In existing technologies, when a flow path for sensitive data (data that requires security management) is recorded, a log generation method is generally adopted. When data is leaked, a task of tracing of a carrier object is cumbersome because the data may have been distributed to different access subjects and no log can completely provide a flow path of the carrier object in an order of access.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The present disclosure provides methods, apparatuses, electronic devices, and storage devices for data security processing, to solve the existing problem of tedious operations of tracing a data leakage after the leakage.

The present disclosure provides a data security processing method, which includes obtaining subject fingerprint information of a current access subject for a carrier object, the subject fingerprint information of the current access subject being used for indicating a flow path of the carrier object; and embedding the subject fingerprint information of the current access subject into the carrier object as a digital watermark.

In implementations, embedding the subject fingerprint information of the current access subject into the carrier object as the digital watermark includes determining that subject fingerprint information of a previous access subject for the carrier object is embedded in a first position in the carrier object as a digital watermark; and embedding the subject fingerprint information of the current access subject into an adjacent position after the first position in the carrier object as the digital watermark.

In implementations, embedding the subject fingerprint information of the current access subject into the carrier object as the digital watermark includes determining whether the carrier object is data that needs to be managed securely; and embedding the subject fingerprint information of the current access subject into the carrier object as the digital watermark if affirmative.

In implementations, embedding the subject fingerprint information of the current access subject into the carrier object as the digital watermark includes obtaining access permission information of the current access subject according to the subject fingerprint information of the current access subject; determining whether the permission information of the current access subject and an operation of the current access subject on the carrier object match a preset operation permission of the current access subject on the carrier object of a current security level; and embedding the subject fingerprint information of the current access subject into the carrier object as the digital watermark if the permission information of the current access subject and the operation of the current access subject on the carrier object match the preset operation permission of the current access subject on the carrier object of the current security level.

In implementations, the method further includes obtaining security management information for the carrier object, the security management information being used for sensing data security risks in the carrier object; embedding the security management information into the carrier object as a digital watermark.

In implementations, security level information of the carrier object is obtained from the security management information that is embedded in the carrier object.

In implementations, the method further includes issuing a warning and returning the subject fingerprint information of the current access subject and the security management information to a data center for preventing data leakages if the permission information of the current access subject and the operation of the current access subject on the carrier object do not match the preset operation permission of the current access subject on the carrier object of the current security level.

In implementations, the carrier object is unstructured data, and obtaining the security management information for the carrier object includes obtaining a sample of the unstructured data; and obtaining security management information of the unstructured data from the sample of the unstructured data.

In implementations, the security management information includes identification information and security level information of the carrier object.

In implementations, the subject fingerprint information of the current access subject includes at least one of identification information of the current access subject, access behavior attribute information of the current access subject, access time information of the current access subject, and address information of the current access subject.

The present disclosure also provides a data source tracing method, which includes obtaining a carrier object; extracting subject fingerprint information of access subjects for the carrier object from the carrier object, the subject fingerprint information of the access subjects being used for indicating a flow path of the carrier object; and determining a data leaker of the carrier object based on the subject fingerprint information of the access subjects.

In implementations, determining the data leaker of the carrier object based on the subject fingerprint information of the access subjects includes obtaining flow path records of the carrier object according to the subject fingerprint information of the access subjects; and setting an access subject corresponding to a last path record in the flow path records of the carrier object as the data leaker of the carrier object.

In implementations, the subject fingerprint information of the access subjects includes at least one of identification information of the access subjects, access behavior attribute information of the access subjects, access time information of the access subjects, and address information of the access subjects.

The present disclosure also provides a data security processing apparatus, which includes a current access subject-subject fingerprint information acquisition unit configured to obtain subject fingerprint information of a current access subject for a carrier object, the subject fingerprint information of the current access subject being used for indicating a flow path of the carrier object; and a current access subject-subject fingerprint information embedding unit configured to embed the subject fingerprint information of the current access subject into the carrier object in a form of a digital watermark.

The present disclosure also provides an electronic device, which includes one or more processors and memory configured to store a program of a data security processing method, the device performing the following operations after being powered on and running the program of the data security processing method through the one or more processors: obtaining subject fingerprint information of a current access subject for a carrier object, the subject fingerprint information of the current access subject being used for indicating a flow path of the carrier object; and embedding the subject fingerprint information of the current access subject into the carrier object in a form of a digital watermark.

The present disclosure also provides a storage device that stores a program of a data security processing method, the program being run by a processor to perform the following operations: obtaining subject fingerprint information of a current access subject for a carrier object, the subject fingerprint information of the current access subject being used for indicating a flow path of the carrier object; and embedding the subject fingerprint information of the current access subject into the carrier object in a form of a digital watermark.

The present disclosure further provides a data source tracing apparatus, which includes a carrier object acquisition unit configured to obtain a carrier object; an access subject-subject fingerprint information extraction unit, configured to extract subject fingerprint information of access subject(s) for the carrier object from the carrier object, the subject fingerprint information of the access subject(s) being used for indicating a flow path of the carrier object; and a data leaker determination unit configured to determine a data leaker of the carrier object according to the subject fingerprint information of the access subject(s).

The present disclosure additionally provides an electronic device, which includes one or more processors and memory configured to store a program of s data source tracing method, the device performing the following operations after being powered on and running the program of the data security processing method through the one or more processors: obtaining a carrier object; extracting subject fingerprint information of access subject(s) for the carrier object from the carrier object, the subject fingerprint information of the access subject(s) being used for indicating a flow path of the carrier object; and determining a data leaker of the carrier object based on the subject fingerprint information of the access subject(s).

The present disclosure also provides a storage device that stores a program of a data source tracing method, the program being run by a processor to perform the following operations: obtaining a carrier object; extracting subject fingerprint information of access subject(s) for the carrier object from the carrier object, the subject fingerprint information of the access subject(s) being used for indicating a flow path of the carrier object; and determining a data leaker of the carrier object based on the subject fingerprint information of the access subject(s).

Compared with the existing technologies, the present disclosure has the following advantages.

The present disclosure provides methods, apparatuses, electronic devices, and storage devices for embedding a watermark. By embedding subject fingerprint information of a current access subject into a carrier object in a form of a digital watermark, a complete record of a flow path of the carrier object is realized, and real-time risk perception and management of a carrier object including sensitive information are realized, thus solving an existing problem of inability of tracing a source of a leakage after data of a carrier object is leaked.

### BRIEF DESCRIPTION OF THE DRAWINGS

FIG. 1 is a flowchart of a data security processing method according to embodiments of the present disclosure.

FIG. 2 is a schematic diagram of a flow path and data source tracing of a carrier object according to the embodiments of the present disclosure.

FIG. 3 is a flowchart of a data security processing method corresponding to an exemplary embodiment according to the embodiments of the present disclosure.

FIG. 4 is a flowchart of a data source tracing method according to the embodiments of the present disclosure.

FIG. 5 is a schematic diagram of a data security processing apparatus according to the embodiments of the present disclosure.

FIG. 6 is a schematic diagram of an electronic device according to the embodiments of the present disclosure.

FIG. 7 is a schematic diagram of a data source tracing apparatus according to the embodiments of the present disclosure.

FIG. 8 is a schematic diagram of an electronic device according to the embodiments of the present disclosure.

### DETAILED DESCRIPTION

A number of specific details are set forth in the following description to enable a full understanding of the present disclosure. However, the present disclosure can be implemented in many other ways that are different from those described herein, and one skilled in the art can make similar generalizations without departing from the content of the present disclosure. Therefore, the present disclosure is not limited by specific implementations disclosed herein.

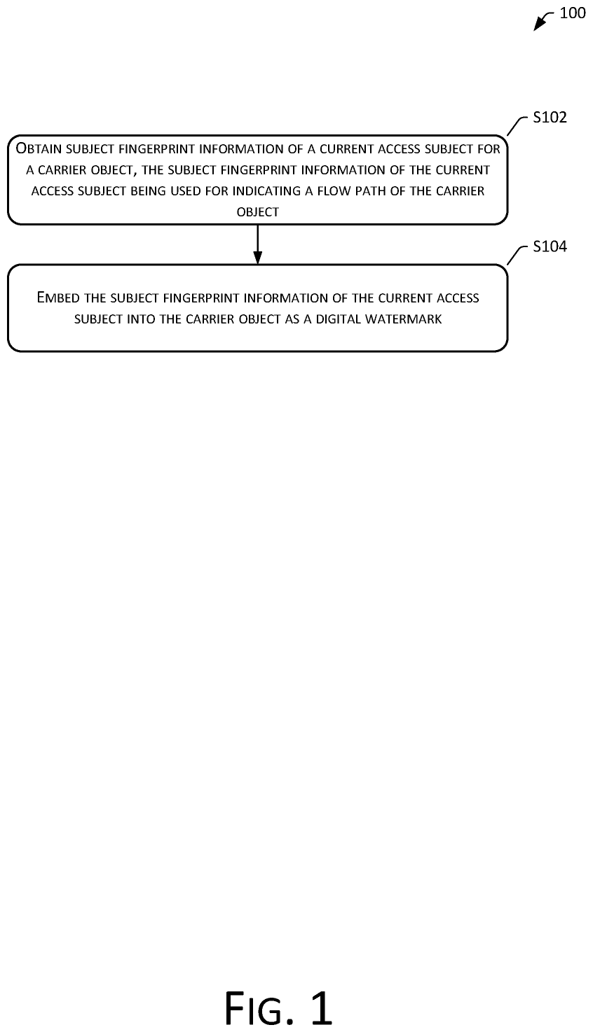

The present disclosure provides a data security processing method, which is described in detail hereinafter with reference to FIGS. 1-3.

As shown in FIG. 1, at S102, subject fingerprint information of a current access subject for a carrier object is obtained, the subject fingerprint information of the current access subject being used for indicating a flow path of the carrier object.

The carrier object includes word document(s), text file(s), picture(s), XML, HTML, various types of reports, image file(s), etc. The carrier object may exist in a distributed system, which may be accessed by multiple access subjects.

The current access subject refers to a subject that is currently performing an operation on the carrier object. For example, multiple access subjects may exist for a carrier object in a distributed system, and an access subject currently accessing the carrier object is a current access subject. The operation includes: sending, editing, copying, etc. For example, if a user 1 wants to send a document A to a user 2, the user 1 is then a current access subject.

The subject fingerprint information of the current access subject includes at least one of identification information of the current access subject, access behavior attribute information of the current access subject, access time information of the current access subject, and address information of the current access subject. The subject fingerprint information of the current access subject is used for indicating a flow path of the carrier object. For example, the current access subject may be determined according to the identification information of the current access subject.

As shown in FIG. 1, at S104, the subject fingerprint information of the current access subject is embedded into the carrier object as a digital watermark.

After the subject fingerprint information of the current access subject is embedded into the carrier object, a complete flow path of the carrier object prior thereto (for example, a flow path in a distributed system) can be obtained through data recovery, no matter which access subject obtains the carrier object. Which access subjects perform what types of operations on the carrier object at what times and places can be obtained from the flow path. After the carrier object is leaked, source tracing can be performed according to the flow path to obtain information of a data leaker of the carrier object.

It should be noted that the current access subject may have been included in the flow path if the current access subject has previously accessed the carrier object before the current access. During the current access, the subject fingerprint information of the current access subject also needs to be embedded into the carrier object as a digital watermark. In other words, the subject fingerprint information of the current access subject is embedded again. For example, if a flow path of a certain carrier object prior to a current access is: an access subject 1, an access subject 2, and an access subject 3, and if a current access subject is the access subject 2, the flow path of the carrier object becomes: the access subject 1, the access subject 2, the access subject 3, and the access subject 2. Embedding the subject fingerprint information of the current access subject again can effectively avoid erroneous source tracing after the carrier object is leaked. For example, if the subject fingerprint information of the access subject 2 is not embedded again, the access subject 3 will be mistakenly taken as the one that leaks the carrier object if the access subject 2 accesses the carrier object after the access subject 3 accesses the carrier object and leaks the carrier object to the access subject 4.

Embedding the subject fingerprint information of the current access subject into the carrier object as the digital watermark includes determining whether the carrier object is data that needs to be managed securely; and embedding the subject fingerprint information of the current access subject into the carrier object as the digital watermark if affirmative.

Before embedding the subject fingerprint information of the current access subject into the carrier object as the digital watermark, a determination is first performed as to whether the carrier object is data that needs to be managed securely. If affirmative, the subject fingerprint information of the current access subject is embedded into the carrier object as the digital watermark. If not, the subject fingerprint information of the current access subject may not be embedded because the carrier object is not sensitive data.

Embedding the subject fingerprint information of the current access subject into the carrier object as the digital watermark includes determining that the subject fingerprint information of a previous access subject for the carrier object is embedded in a first position in the carrier object as a digital watermark; and embedding the subject fingerprint information of the current access subject into an adjacent position after the first position in the carrier object as the digital watermark.

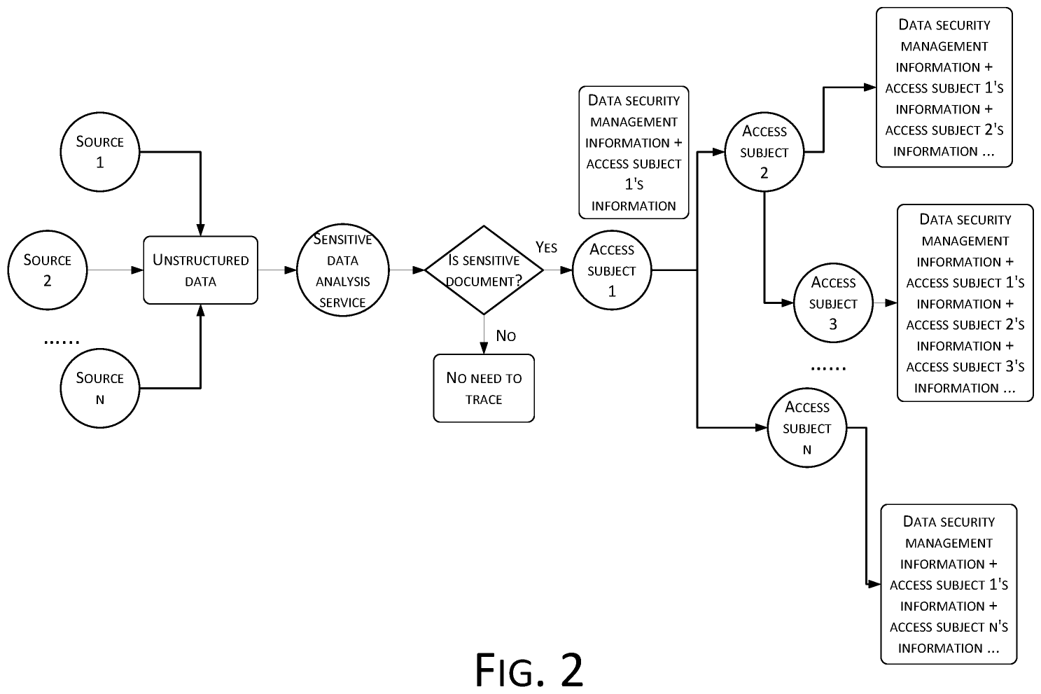

For example, as shown in FIG. 2, if the current access subject is the access subject 2 and the access subject 1 has accessed the carrier object before the access subject 2, the access subject 1 is then the previous access subject. A determination can be performed that subject fingerprint information of the access subject 1 is embedded in a first position in the carrier object, and subject fingerprint information of the current access subject 2 is then embedded in an adjacent position after the first position as a digital watermark. If the current access subject is the access subject 3 and the access subject 2 has accessed the carrier object before the access subject 3, the access subject 2 is then the previous access subject. A determination can be performed that subject fingerprint information of the access subject 2 is embedded in a first position in the carrier object, and subject fingerprint information of the current access subject 3 is then embedded in an adjacent position after the first position as a digital watermark.

Embedding subject fingerprint information of a current access subject in an adjacent position after subject fingerprint information of a previous access object as a digital watermark can form an access flow path for a carrier object. Furthermore, since subject fingerprint information of access objects is embedded according to an order of accesses, a path thereof is completely retained no matter how the carrier object flows. At the same time, a watermark log may also be generated from a flow process of the carrier object. Data leakage and flow rule(s) may be obtained from the log, and intelligent algorithms such as machine learning may be used to perform data leakage prediction and analysis. Therefore, this ensures that a data leaker of a carrier object can be determined according to an access flow path for the carrier object, after data of the carrier object is leaked.

Furthermore, in order to perceive data security risks in the carrier object, the method 100 may further include obtaining security management information for a carrier object, the security management information being used for perceiving data security risks in the carrier object; embedding the security management information into the carrier object as a digital watermark.

The security management information includes identification information and security level information of the carrier object, and may further include attribute information of the carrier object. The attribute information includes information such as a size of the carrier object, a document type of the carrier object, etc.

When the carrier object is unstructured data, obtaining the security management information for the carrier object may include obtaining a sample of the unstructured data; and obtaining security management information of the unstructured data from the sample of the unstructured data.

Embedding the subject fingerprint information of the current access subject into the carrier object as the digital watermark includes obtaining access permission information of the current access subject based on the subject fingerprint information of the current access subject; determining whether the permission information of the current access subject and an operation of the current access subject on the carrier object match a preset operation permission of the current access subject on the carrier object of a current security level; and embedding the subject fingerprint information of the current access subject into the carrier object as the digital watermark if the permission information of the current access subject and the operation of the current access subject on the carrier object match the preset operation permission of the current access subject on the carrier object of the current security level.

The security level information of the carrier object may be obtained from the security management information that is embedded in the carrier object.

Before embedding the subject fingerprint information of the current access object into the carrier object as the digital watermark, a determination may also be made.

A determination is made as to whether permission information of the current access subject and an operation of the current access subject on the carrier object match a preset operation permission of the current access subject on the carrier object of a current security level.

If the permission information of the current access subject and the operation of the current access subject on the carrier object match the preset operation permission of the current access subject on the carrier object of the current security level, embedding is then performed. If the permission information of the current access subject and the operation of the current access subject on the carrier object do not match the preset operation permission of the current access subject on the carrier object of the current security level, a warning is issued, and the subject fingerprint information of the current access subject and the security management information is returned to a data center that is used for preventing data leakages. When a security level of a flowing carrier object does not comply with an access permission of a current access subject or an operation on the carrier object does not comply with the permission, a system can immediately respond and return subject fingerprint information of the current access subject and data security management information, thus realizing immediate risk perception. For example, a level of a current access subject is P5, and a current carrier object is a secret-related technical document. The person with the P5 level set in the system can only view and print the technical document, and cannot edit and forward this technical document. If an operation of the person who currently accesses thereto is legal (for example, viewing and printing the document), fingerprint information thereof can be embedded in the document. If the operation of the person who currently accesses thereto is illegal, a data security warning is issued.

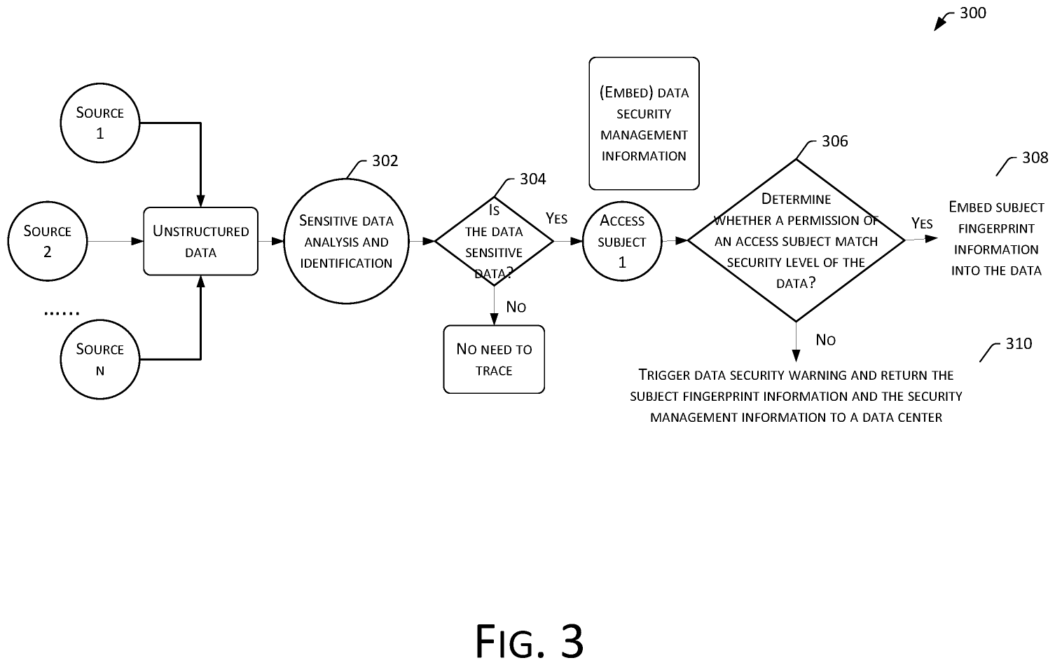

FIG. 3 is a schematic diagram of a data security processing method 300 corresponding to an exemplary embodiment. As shown in FIG. 3, at S302, a sensitive data analysis is performed on unstructured data (a carrier object) through a sensitive data analysis module. At S304, a determination is made as to whether the data (the carrier object) is sensitive data based on a sensitive data analysis result. If affirmative, data security management information is embedded, and S306 is then performed to determine whether permission information of a current access subject and an operation on the carrier object match an operation permission of the current access subject preset in a system for the carrier object of a current security level. If affirmative, S308 is performed to embed fingerprint information of the current access subject into the data. If not, S310 is performed to issue a warning, and return access the subject fingerprint information of the current access subject and the security management information to a data center that is used for preventing data leakages.

In order to explain the method of the first embodiment of the present disclosure more clearly, two specific examples are given below in combination with scenarios.

### Example 1

Xiao Zhang is a current access subject, and downloads an excel document A (a carrier object) from a Ding drive. Prior thereto, the document A has passed through a sensitive data analysis module. Combining with service scenarios and using some policies and rules, a security level (such as P0, P1, etc.) of the document or a type of data (such as personal sensitive data or directly identifiable personal data) is obtained, and is embedded into the document A with an addition of data attributes and data IDs using a digital watermarking method. In other words, data security management information of the document A is embedded into the document A. When Xiao Zhang obtains the document A and performs an operation (sending/editing/duplicating) on the document A, the security management information (including security level information) of the document is extracted through a label information recovery module of data management software, and in combination with fingerprint information (work ID, department, rank, etc.) of Xiao Zhang, a determination of whether the current operation is legal is performed. For example, the document A is a salary information table for all employees of a company. Only personnel in a financial department have a permission to view or modify. As such, Xiao Zhang, being an ordinary employee, will automatically trigger a data security warning when he opens the table. The subject fingerprint information of Xiao Zhang and the security management information is returned to a data center altogether, and personnel of a safety department can respond immediately to prevent a leakage of important data. If the document is only a technical document and a security level thereof is set as internally public, then the fingerprint information of Xiao Zhang is embedded into the document as a digital watermark, and the current operation is completed.

### Example 2

A document A is assumed to be a technical document. After Xiao Zhang obtains the document A, he finds it very useful, and shares the document A with his colleague Xiao Li. In this case, fingerprint information of Xiao Li is embedded into the document A as a digital watermark, and is located after information of Xiao Zhang. By analogy, no matter how many access subjects the data has flowed through, as long as embedded watermark information in the data can be restored, a flow path and historical access data of the data are clear at a glance.

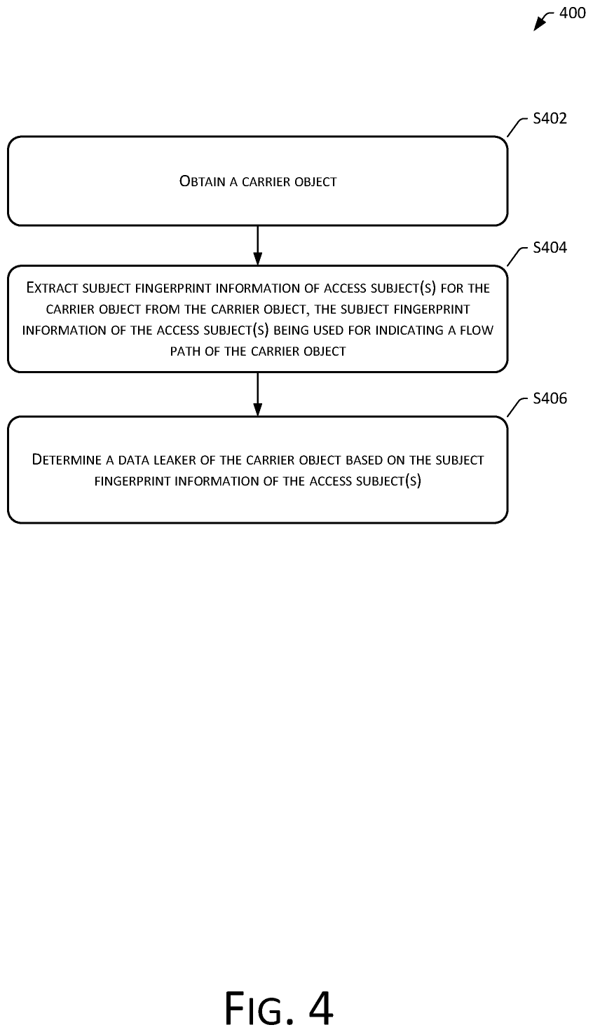

The present disclosure provides a data source tracing method 400, which is described in detail below with reference to FIG. 4.

As shown in FIG. 4, at S402, a carrier object is obtained.

The carrier object includes word document(s), text file(s), picture(s), XML, HTML, various types of reports, image file(s), etc. The carrier object in this implementation is a carrier object that encounters a data leakage, and a flow path of the carrier object needs to be traced to determine a data leaker of the carrier object. The carrier object is a carrier object in which subject fingerprint information of access subject(s) is embedded.

As shown in FIG. 4, at S404, subject fingerprint information of access subject(s) for the carrier object is extracted from the carrier object, the subject fingerprint information of the access subject(s) being used for indicating a flow path of the carrier object.

As shown in FIG. 4, at S406, a data leaker of the carrier object is determined based on the subject fingerprint information of the access subject(s).

The subject fingerprint information of the access subject(s) includes at least one of identification information of the access subject(s), and access behavior attribute information of the access subject(s), access time information of the access subject(s), or address information of the access subject(s).

Determining the data leaker of the carrier object based on the subject fingerprint information of the access subject(s) includes obtaining flow path records of the carrier object based on the subject fingerprint information of the access subject(s); setting an access subject corresponding to a last path record in the flow path records of the carrier object as the data leaker of the carrier object.

In order to explain the method of the second embodiment of the present disclosure more clearly, a specific example is given below in combination with a scenario.

Example 2 of the first embodiment of the present disclosure is still used: Following the above text, Xiao Li obtains the document A from Xiao Zhang. He finds it to be particularly useful, and so he sends this technical document A to his friend (an employee not belonging to the company) with selfish motives through DingTalk. However, the data is internal information and cannot be made public, and a determination can be made that a data leakage occurs. At this time, when the leaked document A is obtained externally, both the data security management information and access subject information embedded in the document A can be extracted through a data recovery module. Since a complete flow path record exists, the last subject of the record is Xiao Li, i.e., the leaked person is Xiao Li. Another situation is that Xiao Li only edits and completes the document A. So his operation is in compliance with a permission thereof, and a data leakage warning is not triggered.

Corresponding to the data security processing method as described above, the present disclosure further provides a data security processing apparatus.

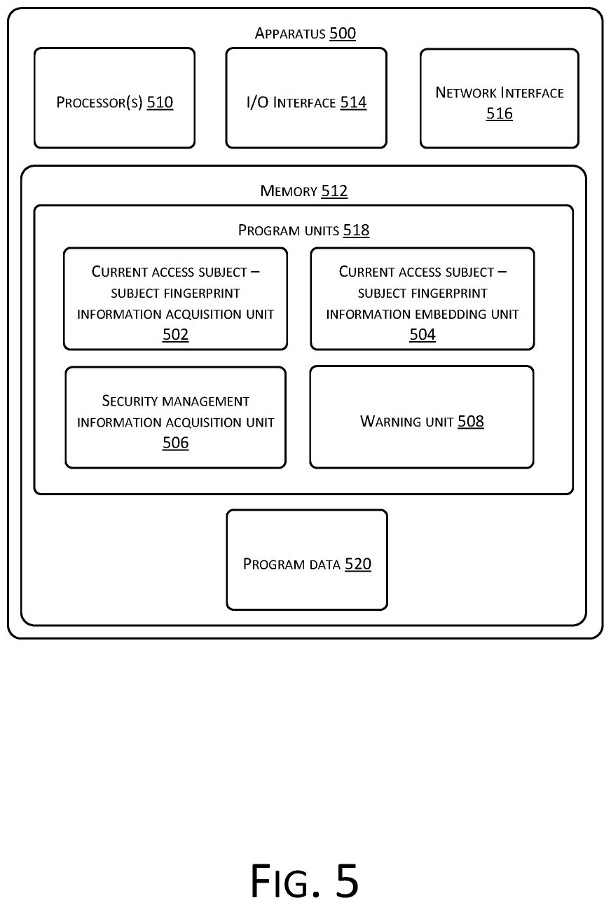

As shown in FIG. 5, a data security processing apparatus 500 may include a current access subject-subject fingerprint information acquisition unit 502 configured to obtain subject fingerprint information of a current access subject for a carrier object, the subject fingerprint information of the current access subject being used for indicating a flow path of the carrier object; and a current access subject-subject fingerprint information embedding unit 504 configured to embed the subject fingerprint information of the current access subject into the carrier object as a digital watermark.

In implementations, the current access subject-subject fingerprint information embedding unit 504 may further be configured to determine that subject fingerprint information of a previous access subject for the carrier object is embedded in a first position in the carrier object in a digital watermark manner; and embed the subject fingerprint information of the current access subject as the digital watermark in an adjacent position after the first position in the carrier object.

In implementations, the current access subject-subject fingerprint information embedding unit 504 may further be configured to determine whether the carrier object is data that needs to be managed securely; and embed the subject fingerprint information of the current access subject into the carrier object as the digital watermark if affirmative.

In implementations, the current access subject-subject fingerprint information embedding unit 504 may further be configured to obtain access permission information of the current access subject according to the subject fingerprint information of the current access subject; determine whether the permission information of the current access subject and an operation on the carrier object match a preset operation permission of the current access subject on the carrier object of a current security level; and embed the subject fingerprint information of the current access subject into the carrier object as the digital watermark if the permission information of the current access subject and the operation on the carrier object match the preset operation permission of the current access subject on the carrier object of the current security level.

In implementations, the apparatus 500 may further include a security management information acquisition unit 506 configured to obtain security management information for the carrier object, the security management information being used for sensing data security risks in the carrier object; and a security management information embedding unit configured to embed the security management information into the carrier object using a digital watermarking method.

In implementations, security level information of the carrier object is obtained from the security management information that is embedded in the carrier object.

In implementations, the apparatus 500 may further include a warning unit 508 configured to issue a warning and return the subject fingerprint information of the current access subject and the security management information to a data center used for preventing data leakages if the permission information of the current access subject and operation on the carrier object does not match the preset operation permission of the current access subject for the carrier object of the current security level.

In implementations, the carrier object is unstructured data, and the security management information acquisition unit is specifically configured to obtain a sample of the unstructured data, and obtain the security management information of the unstructured data from the sample of the unstructured data.

In implementations, the security management information includes identification information and security level information of the carrier object.

In implementations, the subject fingerprint information of the current access subject includes at least one of identification information of the current access subject, and access behavior attribute information of the current access subject, access time information of the current access subject, and address information of the current access subject.

In implementations, the apparatus 500 may further include one or more processors 510, memory 512, an input/output (I/O) interface 514, and a network interface 516.

The memory 512 may include a form of computer readable media such as a volatile memory, a random access memory (RAM) and/or a non-volatile memory, for example, a read-only memory (ROM) or a flash RAM. The memory 512 is an example of a computer readable media.

The computer readable media may include a volatile or non-volatile type, a removable or non-removable media, which may achieve storage of information using any method or technology. The information may include a computer readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 512 may include program units 518 and program data 520. The program units 518 may include one or more units as described in the foregoing description and shown in FIG. 5.

It should be noted that, for a detailed description of the data security processing apparatus, references can be made to the related description of the data security processing method of the present disclosure, and details thereof are not redundantly described herein.

Corresponding to the data security processing method as described above, the present disclosure further provides an electronic device.

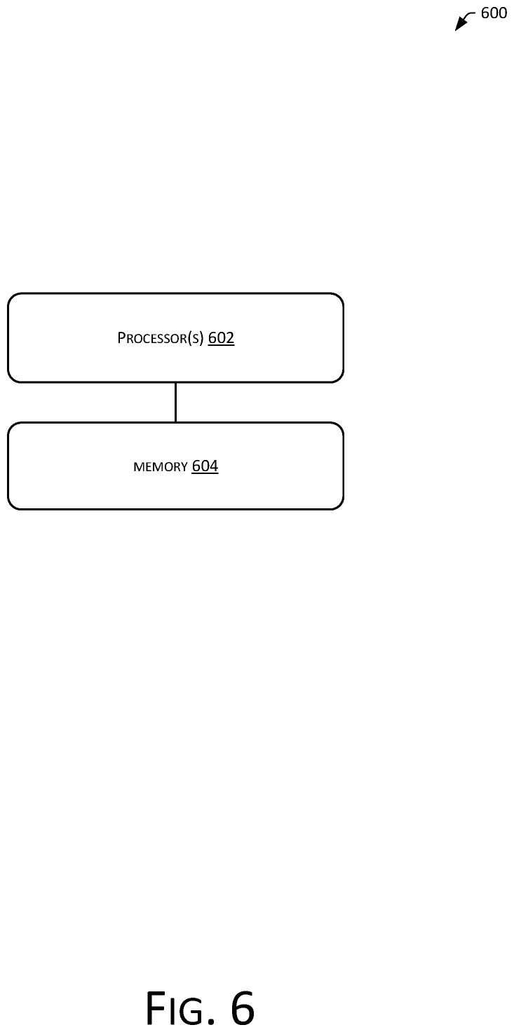

As shown in FIG. 6, an electronic device 600 may include one or more processors 602, and memory 604 configured to store a program of a data security processing method. The electronic device 600 may perform the following operations after being powered on and running the program of the data security processing method through the one or more processors 602: obtaining subject fingerprint information of a current access subject for a carrier object, the subject fingerprint information of the current access subject being used for indicating a flow path of the carrier object; and embedding the subject fingerprint information of the current access subject into the carrier object as a digital watermark.

In implementations, embedding the subject fingerprint information of the current access subject into the carrier object as the digital watermark includes determining that subject fingerprint information of a previous access subject for the carrier object is embedded in a first position in the carrier object in a digital watermarking manner; and embedding the subject fingerprint information of the current access subject as the digital watermark in an adjacent position after the first position in the carrier object.

In implementations, embedding the subject fingerprint information of the current access subject into the carrier object as the digital watermark includes determining whether the carrier object is data that needs to be managed securely; and embedding the fingerprint information of the subject of the current access subject into the carrier object as the digital watermark if affirmative.

In implementations, embedding the subject fingerprint information of the current access subject into the carrier object as the digital watermark includes obtaining access permission information of the current access subject according to the subject fingerprint information of the current access subject; determining whether the access permission information matches security level information of the carrier object; and embedding the subject fingerprint information of the current access subject into the carrier object as the digital watermark if a match exists.

In implementations, the electronic device 600 may further perform the following operation: obtaining security management information for the carrier object, the security management information being used for sensing data security risks in the carrier object; and embedding the security management information into the carrier object in a digital watermark manner.

In implementations, security level information of the carrier object is obtained from the security management information that is embedded in the carrier object.

In implementations, the electronic device 600 may further perform the following operation: issuing a warning, and returning the subject fingerprint information of the current access subject and the security management information to a data center used for preventing data leakages if no match exists.

In implementations, the carrier object is unstructured data, and obtaining the security management information for the carrier object includes obtaining a sample of the unstructured data; and obtaining the security management information of the unstructured data from the sample of the unstructured data.

In implementations, the security management information includes identification information and security level information of the carrier object.

In implementations, the subject fingerprint information of the current access subject includes at least one of identification information of the current access subject, and access behavior attribute information of the current access subject, access time information of the current access subject, and address information of the current access subject.

It should be noted that, for a detailed description of the electronic device of the present disclosure, references can be made to the related description of the data security processing method of the present disclosure, and details thereof are not redundantly described herein.

Corresponding to the data security processing method provided above, the present disclosure further provides a storage device that stores a program of the data security processing method. The program, when being run by one or more processors, cause the one or more processors to perform the following operations: obtaining subject fingerprint information of a current access subject for a carrier object, the subject fingerprint information of the current access subject being used for indicating a flow path of the carrier object; and embedding the subject fingerprint information of the current access subject into the carrier object as a digital watermark.

It should be noted that, for a detailed description of the storage device provided above, references can be made to the related description of the data security processing method of the present disclosure, and details thereof are not redundantly described herein.

Corresponding to the data source tracing method described in the foregoing description, the present disclosure also provides a data source tracing apparatus.

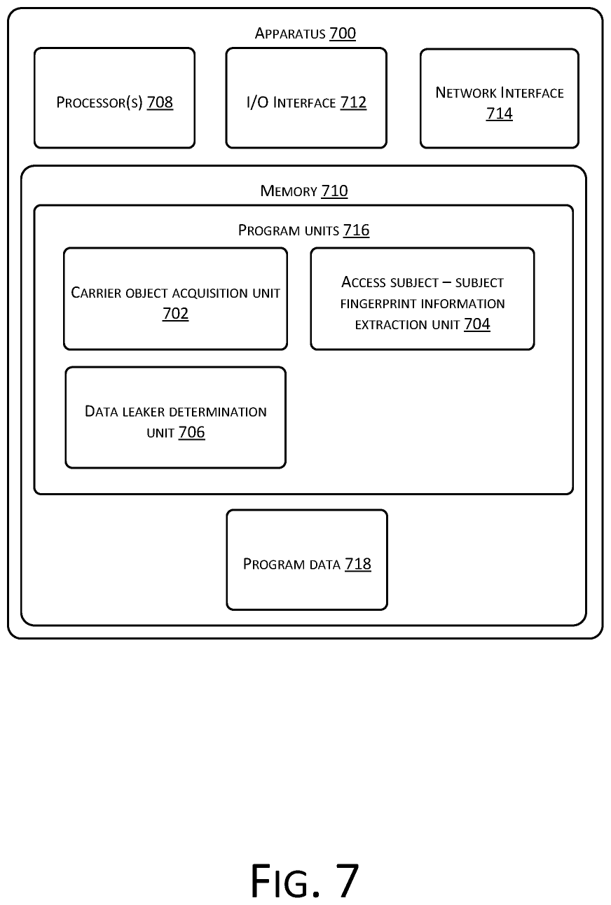

As shown in FIG. 7, a data source tracing apparatus 700 may include a carrier object acquisition unit 702 configured to obtain a carrier object; an access subject-subject fingerprint information extraction unit 704 configured to extract subject fingerprint information of access subject(s) for the carrier object from the carrier object, the subject fingerprint information of the access subject(s) being used for indicating a flow path of the carrier object; and a data leaker determination unit 706 configured to determine a data leaker of the carrier object based on the subject fingerprint information of the access subject(s).

In implementations, the data leaker determination unit 706 may further be configured to obtain flow path records of the carrier object according to the subject fingerprint information of the access subject(s); and set an access subject corresponding to the last path record in the flow path records of the carrier object as the data leaker of the carrier object.

In implementations, the subject fingerprint information of the access subject(s) includes at least one of identification information of the access subject(s), and access behavior attribute information of the access subject(s), access time information of the access subject(s), or address information of the access subject(s).

It should be noted that, for a detailed description of the data source tracing apparatus provided above, references may be made to the related description of the data source tracing method of the present disclosure, and details thereof are not redundantly described herein.

Corresponding to the data source tracing method described in the foregoing description, the present disclosure further provides an electronic device.

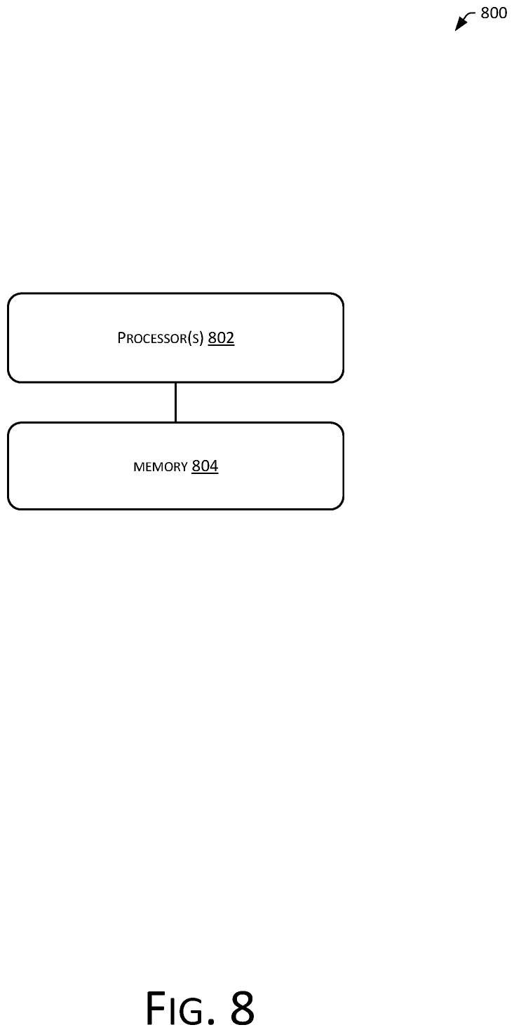

As shown in FIG. 8, an electronic device may include one or more processors 802, and memory 804 configured to store a program of a data source tracing method. The electronic device 800, after being powered on and running the program of the data source tracing method through the one or more processors 802, perform the following operations: obtaining a carrier object; extracting subject fingerprint information of access subject(s) for the carrier object from the carrier object, the subject fingerprint information of the access subject(s) being used for indicating a flow path of the carrier object; and determining a data leaker of the carrier object based on the subject fingerprint information of the access subject(s).

In implementations, determining the data leaker of the carrier object based on the subject fingerprint information of the access subject(s) includes obtaining flow path records of the carrier object based on the subject fingerprint information of the access subject(s); and setting an access subject corresponding to the last path record in the flow path records of the carrier object as the data leaker of the carrier object.

In implementations, the subject fingerprint information of the access subject(s) includes at least one of identification information of the access subject(s), and access behavior attribute information of the access subject(s), access time information of the access subject(s), and address information of the access subject(s).

In implementations, the apparatus 700 may further include one or more processors 708, memory 710, an input/output (I/O) interface 712, and a network interface 714.

The memory 710 may include a form of computer readable media as described in the foregoing description. In implementations, the memory 710 may include program units 716 and program data 718. The program units 716 may include one or more units as described in the foregoing description and shown in FIG. 7.

It should be noted that, for a detailed description of the electronic device provided above, references may be made to the related description of the data source tracing method of the present disclosure, and details thereof are not redundantly described herein.

Corresponding to the data source tracing method described in the foregoing description, the present disclosure also provides a storage device that stores a program of a data source tracing method. The program, when being run by one or more processors, cause the one or more processors to perform the following operations: obtaining a carrier object; extracting subject fingerprint information of access subject(s) for the carrier object from the carrier object, the subject fingerprint information of the access subject(s) being used for indicating a flow path of the carrier object; and determining a data leaker of the carrier object based on the subject fingerprint information of the access subject(s).

It should be noted that, for a detailed description of the storage device provided above, references may be made to the related description of the data source tracing method of the present disclosure, and details thereof are not redundantly described herein.

Although the present disclosure is disclosed above using exemplary embodiments, these exemplary embodiments are not intended to limit the present disclosure. One skilled in the art can make possible changes and modifications without departing from the spirit and scope of the present disclosure. Therefore, the scope of protection shall be subject to the scope defined by the claims of the present disclosure.

In a typical configuration, a computing device includes one or more processors (CPUs), an input/output interface, a network interface, and memory.

One skilled in the art should understand that the embodiments of the present disclosure may be provided as a method, a system, or a computer program product. Therefore, the present disclosure may take a form of an entirely hardware embodiment, an entirely software embodiment, or an embodiment having a combination of aspects of software and hardware. Moreover, the present disclosure may take a form of a computer program product implemented on one or more computer usable storage media (which include, but are not limited to, a magnetic disk, CD-ROM, an optical disk, etc.) that include computer usable program codes.

The present disclosure may be further be understood using the following clauses.

Clause 1: A data security processing method including: obtaining subject fingerprint information of a current access subject for a carrier object, the subject fingerprint information of the current access subject being used for indicating a flow path of the carrier object; and embedding the subject fingerprint information of the current access subject into the carrier object as a digital watermark.

Clause 2: The method of Clause 1, wherein embedding the subject fingerprint information of the current access subject into the carrier object as the digital watermark includes: determining that subject fingerprint information of a previous access subject for the carrier object is embedded in a first position in the carrier object in a digital watermarking manner; and embedding the subject fingerprint information of the current access subject into an adjacent position after the first position in the carrier object as the digital watermark.

Clause 3: The method of Clause 1, wherein embedding the subject fingerprint information of the current access subject into the carrier object as the digital watermark includes: determining whether the carrier object is data that needs to be managed securely; and embedding the subject fingerprint information of the current access subject into the carrier object as the digital watermark if affirmative.

Clause 4: The method of Clause 3, wherein embedding the subject fingerprint information of the current access subject into the carrier object as the digital watermark includes: obtaining access permission information of the current access subject according to the subject fingerprint information of the current access subject; determining whether the permission information of the current access subject and an operation of the current access subject on the carrier object match a preset operation permission of the current access subject on the carrier object of a current security level; and embedding the subject fingerprint information of the current access subject into the carrier object as the digital watermark if the permission information of the current access subject and the operation of the current access subject on the carrier object match the preset operation permission of the current access subject on the carrier object of the current security level.

Clause 5: The method of Clause 4, further including: obtaining security management information for the carrier object, the security management information being used for sensing data security risks in the carrier object; and embedding the security management information into the carrier object as a digital watermark.

Clause 6: The method of Clause 5, wherein security level information of the carrier object is obtained from the security management information that is embedded in the carrier object.

Clause 7: The method of Clause 4, further including: issuing a warning, and returning the subject fingerprint information of the current access subject and the security management information to a data center for preventing data leakages if the permission information of the current access subject and the operation of the current access subject on the carrier object do not match the preset operation permission of the current access subject on the carrier object of the current security level.

Clause 8: The method of Clause 5, wherein the carrier object is unstructured data, and obtaining the security management information for the carrier object includes: obtaining a sample of the unstructured data; and obtaining security management information of the unstructured data from the sample of the unstructured data.

Clause 9: The method of Clause 1, wherein the security management information includes identification information and security level information of the carrier object.

Clause 10: The method of Clause 1, wherein the subject fingerprint information of the current access subject includes at least one of identification information of the current access subject, access behavior attribute information of the current access subject, access time information of the current access subject, or address information of the current access subject.

Clause 11: A data source tracing method including: obtaining a carrier object; extracting subject fingerprint information of access subjects for the carrier object from the carrier object, the subject fingerprint information of the access subjects being used for indicating a flow path of the carrier object; and determining a data leaker of the carrier object based on the subject fingerprint information of the access subjects.

Clause 12: The method of Clause 11, wherein determining the data leaker of the carrier object based on the subject fingerprint information of the access subjects includes: obtaining flow path records of the carrier object according to the subject fingerprint information of the access subjects; and setting an access subject corresponding to a last path record in the flow path records of the carrier object as the data leaker of the carrier object.

Clause 13: The method of Clause 11, wherein the subject fingerprint information of the access subjects includes at least one of identification information of the access subjects, access behavior attribute information of the access subjects, access time information of the access subjects, or address information of the access subjects.

Clause 14: A data security processing apparatus including: a current access subject-subject fingerprint information acquisition unit configured to obtain subject fingerprint information of a current access subject for a carrier object, the subject fingerprint information of the current access subject being used for indicating a flow path of the carrier object; and a current access subject-subject fingerprint information embedding unit configured to embed the subject fingerprint information of the current access subject into the carrier object in a form of a digital watermark.

Clause 15: An electronic device including: a processor; and memory configured to store a program of a data security processing method, wherein the device, after being powered on and running the program of the data security processing method through the processor, performs the following operations: obtaining subject fingerprint information of a current access subject for a carrier object, the subject fingerprint information of the current access subject being used for indicating a flow path of the carrier object; and embedding the subject fingerprint information of the current access subject into the carrier object in a form of a digital watermark.

Clause 16: A storage device storing a program of a data security processing method, the program being run by a processor to perform the following operations: obtaining subject fingerprint information of a current access subject for a carrier object, the subject fingerprint information of the current access subject being used for indicating a flow path of the carrier object; and embedding the subject fingerprint information of the current access subject into the carrier object in a form of a digital watermark.

Clause 17: A data source tracing apparatus including: a carrier object acquisition unit configured to obtain a carrier object; an access subject-subject fingerprint information extraction unit configured to extract subject fingerprint information of access subjects for the carrier object from the carrier object, the subject fingerprint information of the access subjects being used for indicating a flow path of the carrier object; and a data leaker determination unit configured to determine a data leaker of the carrier object according to the subject fingerprint information of the access subjects.

Clause 18: An electronic device including: a processor; and memory configured to store a program of s data source tracing method, wherein the device, after being powered on and running the program of the data security processing method through the processor, performs the following operations: obtaining a carrier object; extracting subject fingerprint information of access subjects for the carrier object from the carrier object, the subject fingerprint information of the access subjects being used for indicating a flow path of the carrier object; and determining a data leaker of the carrier object based on the subject fingerprint information of the access subjects.

Clause 19: A storage device storing a program of a data source tracing method, the program being run by a processor to perform the following operations: obtaining a carrier object; extracting subject fingerprint information of access subjects for the carrier object from the carrier object, the subject fingerprint information of the access subjects being used for indicating a flow path of the carrier object; and determining a data leaker of the carrier object based on the subject fingerprint information of the access subjects.

What is claimed is:

1. A method implemented by one or more computing devices, the method comprising:
obtaining subject fingerprint information of a current access subject for a carrier object, the subject fingerprint information of the current access subject being used for indicating a flow path of the carrier object; and
embedding the subject fingerprint information of the current access subject into the carrier object as a digital watermark.

2. The method of claim 1, wherein embedding the subject fingerprint information of the current access subject into the carrier object as the digital watermark comprises:
determining that subject fingerprint information of a previous access subject for the carrier object is embedded in a first position in the carrier object in a digital watermarking manner; and
embedding the subject fingerprint information of the current access subject into an adjacent position after the first position in the carrier object as the digital watermark.

3. The method of claim 1, wherein embedding the subject fingerprint information of the current access subject into the carrier object as the digital watermark comprises:
determining whether the carrier object is data that needs to be managed securely; and
embedding the subject fingerprint information of the current access subject into the carrier object as the digital watermark if affirmative.

4. The method of claim 3, wherein embedding the subject fingerprint information of the current access subject into the carrier object as the digital watermark comprises:
obtaining access permission information of the current access subject according to the subject fingerprint information of the current access subject;
determining whether the permission information of the current access subject and an operation of the current access subject on the carrier object match a preset operation permission of the current access subject on the carrier object of a current security level; and
embedding the subject fingerprint information of the current access subject into the carrier object as the digital watermark if the permission information of the current access subject and the operation of the current access subject on the carrier object match the preset operation permission of the current access subject on the carrier object of the current security level.

5. The method of claim 4, further comprising:
obtaining security management information for the carrier object, the security management information being used for sensing data security risks in the carrier object; and
embedding the security management information into the carrier object as a digital watermark.

6. The method of claim 5, wherein security level information of the carrier object is obtained from the security management information that is embedded in the carrier object.

7. The method of claim 5, wherein the carrier object is unstructured data, and obtaining the security management information for the carrier object comprises:
obtaining a sample of the unstructured data; and
obtaining security management information of the unstructured data from the sample of the unstructured data.

8. The method of claim 4, further comprising:
issuing a warning, and returning the subject fingerprint information of the current access subject and the security management information to a data center for preventing data leakages if the permission information of the current access subject and the operation of the current access subject on the carrier object do not match the preset operation permission of the current access subject on the carrier object of the current security level.

9. The method of claim 1, wherein the security management information comprises identification information and security level information of the carrier object.

10. The method of claim 1, wherein the subject fingerprint information of the current access subject comprises at least one of identification information of the current access subject, access behavior attribute information of the current access subject, access time information of the current access subject, or address information of the current access subject.

11. An apparatus comprising:
one or more processors; and
memory storing executable instructions that, when executed by the one or more processors, cause the one or more processors to perform acts comprising:
obtaining a carrier object;
extracting subject fingerprint information of access subjects for the carrier object from the carrier object, the subject fingerprint information of the access subjects being used for indicating a flow path of the carrier object; and
determining a data leaker of the carrier object based on the subject fingerprint information of the access subjects.

12. The apparatus of claim 11, wherein determining the data leaker of the carrier object based on the subject fingerprint information of the access subjects comprises:
obtaining flow path records of the carrier object according to the subject fingerprint information of the access subjects; and
setting an access subject corresponding to a last path record in the flow path records of the carrier object as the data leaker of the carrier object.

13. The apparatus of claim 11, wherein the subject fingerprint information of the access subjects comprises at least one of identification information of the access subjects, access behavior attribute information of the access subjects, access time information of the access subjects, or address information of the access subjects.

14. One or more computer readable media storing executable instructions that, when executed by one or more processors, cause the one or more processors to perform acts comprising:
obtaining subject fingerprint information of a current access subject for a carrier object, the subject fingerprint information of the current access subject being used for indicating a flow path of the carrier object; and
embedding the subject fingerprint information of the current access subject into the carrier object as a digital watermark.

15. The one or more computer readable media of claim 14, wherein embedding the subject fingerprint information of the current access subject into the carrier object as the digital watermark comprises:
determining that subject fingerprint information of a previous access subject for the carrier object is embedded in a first position in the carrier object in a digital watermarking manner; and
embedding the subject fingerprint information of the current access subject into an adjacent position after the first position in the carrier object as the digital watermark.

16. The one or more computer readable media of claim 14, wherein embedding the subject fingerprint information of the current access subject into the carrier object as the digital watermark comprises:
determining whether the carrier object is data that needs to be managed securely; and
embedding the subject fingerprint information of the current access subject into the carrier object as the digital watermark if affirmative.

17. The one or more computer readable media of claim 16, wherein embedding the subject fingerprint information of the current access subject into the carrier object as the digital watermark comprises:
obtaining access permission information of the current access subject according to the subject fingerprint information of the current access subject;
determining whether the permission information of the current access subject and an operation of the current access subject on the carrier object match a preset operation permission of the current access subject on the carrier object of a current security level; and
embedding the subject fingerprint information of the current access subject into the carrier object as the digital watermark if the permission information of the current access subject and the operation of the current access subject on the carrier object match the preset operation permission of the current access subject on the carrier object of the current security level.

18. The one or more computer readable media of claim 17, the acts further comprising:
obtaining security management information for the carrier object, the security management information being used for sensing data security risks in the carrier object; and
embedding the security management information into the carrier object as a digital watermark.

19. The one or more computer readable media of claim 18, wherein the carrier object is unstructured data, and obtaining the security management information for the carrier object comprises:
obtaining a sample of the unstructured data; and
obtaining security management information of the unstructured data from the sample of the unstructured data.

20. The one or more computer readable media of claim 17, the acts further comprising:
issuing a warning, and returning the subject fingerprint information of the current access subject and the security management information to a data center for preventing data leakages if the permission information of the current access subject and the operation of the current access subject on the carrier object do not match the preset operation permission of the current access subject on the carrier object of the current security level.
